(19) United States
(12) Patent Application Publication
(10) Pub. No.: US 2016/0106254 A1
(43) Pub. Date: Apr. 21, 2016

(54) DOSING COFFEE BY MEANS OF ILLUMINATING DEVICES

(71) Applicant: Jean-Claude EYRIGNOUX, Brive-la-Gaillarde (FR)

(72) Inventor: Jean-Claude EYRIGNOUX, Brive-la-Gaillarde (FR)

(21) Appl. No.: 14/784,683

(22) PCT Filed: Apr. 7, 2014
(86) PCT No.: PCT/IB2014/000507

§ 371 Date: Dec. 9, 2015

(30) Foreign Application Priority Data
Apr. 17, 2013 (FR) 13 00902

(51) Int. Cl. A47J 31/06; F21V 33/00; F21S 9/02; F21V 31/00; F21V 23/04

(52) U.S. Cl. CPC A47J 31/06; F21V 31/00; F21V 23/0442; F21S 9/02; F21V 33/0024; A47J 2031/0694; F21W 2111/00

(57) ABSTRACT

The invention relates to a device for dosing powdered coffee into a coffee maker having a filter made of paper or synthetic fibre in the form of a truncated cone or with a flat bottom, characterised in that the graduations of the dosing level are projected onto the coffee filter by means of the illuminating light, and a graduated mask.

This innovation relates to the measuring of coffee powder by means of light in all kinds of filters, those made of paper and of synthetic fiber, with a truncated cone shape having a straight base, or a truncated cone having an American-type flat bottom, placed in electric coffee makers or non-electric filter holders. Said light comes from a light source, with the graduations to be used being projected on the faces of the filter, through a perforated or transparent mask. Or said light passing through the transparent walls of the filter holder, with said graduations then being rendered opaque. Or else by means of LED (Light Emitting Diodes) light graduations that are supported or incorporated into a light unit with the filter holder.

The object is to offer to consumers a device for measuring of coffee powder that is identical to the measuring present on the water reservoir. The device requires no intervention on the part of the consumer; by simply reading graduations projected on the filter or around the opaque graduations, the ground coffee powder is poured directly from the package into the filter, in accordance with the desired number of cups of coffee.

At present, coffee makers come with measuring spoons, generally made of plastic in conical shape. Using this spoon, the consumer takes the powder from the package then pours it into the filter; this is not optimum. The filling of the spoon can vary; the measuring from it is haphazard. Because of this, a number of consumers (75% of men and 50% of women) do not use it and pour the powder directly into the filter. Consequently, the coffee is too strong or too weak; ultimately, there is disenchantment with filter coffee makers. However, the latter remains the only device capable of preparing coffee in large volume at the lowest cost. While the worldwide production of coffee is in surplus, people have little or no access to this beverage whose advantages for health are acknowledged. Of course, capsules are a major advance for cups per unit of good quality, but these devices are as unsuitable for preparing four or six cups of coffee as the filter coffee maker is for a cup per unit. In addition, cups per capsule cost much more and they are unavailable to a very large proportion of people, particularly to people in less developed countries. These devices generate a great deal of waste, and can be negatively perceived in terms of the environment. Moreover, the amount of coffee consumed by this means remains very low.

Under these circumstances, it is appropriate to revive the filter coffee maker in all of its forms, particularly those with paper filters, by equipping it with a direct, simple and inexpensive measuring device.

The raw material used to produce paper filters is mainly the paper pulp that comes from bamboo, which takes only three years to grow.

Filter paper is very economical; it is consistent with a sustainable growth cycle. The quality of its filtering is recognized as unsurpassed, both for the capturing of aromas and the retaining of oils.

Until now, the difficulty in developing a measuring device arises from the fact that there is no reliable and economical means of printing markings on the filter paper that meets dietary requirements. This innovation overcomes this obstacle by proposing to use a means to create measurement marks without touching the paper and without an insert in the filter, by using artificial and/or natural light.

In the current state of the art, two families of solutions are found in patents, all with direct reading of the graduations. The first relates to marking on the paper of the filter (patent EP 2057923 A1). The second is a series of graduated inserts to be placed in the filter (patents: DE 196 06 775 A1 or WO 02/1579 A1).

This innovation is a third, novel way; it aims to use light to create virtual images on the filter that are either the graduations themselves or the spaces between and around the graduations.

The principle is simple: for example, a mask perforated with graduations is placed between a light source and the outer wall of the filter. The light beams pass through the mask and project the graduations onto the outer face of the filter; they then become very readable. Or conversely, the light passes through a partially or totally transparent filter holder on or in which the graduations are opaque. In this second case, the illuminated surface is larger. This is suited to a pourer for the manually-operated, non-electric filter holder.

To avoid deformation and to ensure good readability, the paper must be firmly pressed against the graduated zone of the filter holder. For this purpose, the filter holder is equipped at its base and on its sides with spaces that are able to accommodate, with play, the crimped strips of the filter.

The use of natural ambient light can be sufficient in certain cases. For example, the natural light of the sun or even the lighting of the kitchen, enhanced by a reflective surface, makes it possible to read the graduation on a non-electric filter holder. This configuration is most advantageous for consumers in developing countries.

Recent filter coffee makers are more and more often equipped with electronic elements along with a water heating element; the electric power can inexpensively be recovered to power the illuminating source proposed for the graduations. The illumination itself can be the same for the nameplate of the coffee maker and the projection of the graduations on the filter. In this way, LED lights offer many possibilities. They are powerful, easy to install, offer a wide variety of colors, do not heat up, and are inexpensive.

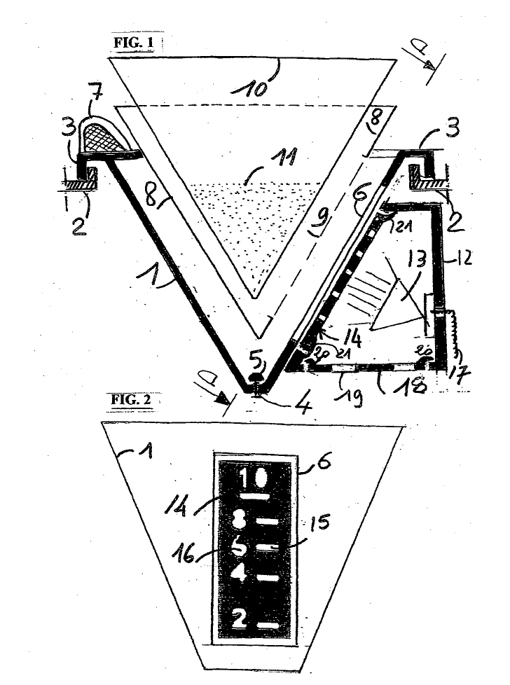

FIGS. 1 to 10 show several embodiments of the innovation with its different characteristics.

According to one characteristic, the graduations are projected onto the coffee filter by means of at least one light source.

According to another characteristic, the space between and the space that surrounds the graduations are projected against the coffee filter.

According to another characteristic, the light beams are filtered by means of a mask perforated with graduations to be projected.

Conversely, according to another characteristic, the transparent mask is provided with opaque graduations.

According to another characteristic, the measuring can be varied by interchangeable masks or interchangeable filter holders.

According to another characteristic, the light beams are filtered by means of an opaque wall in which transparent graduations are provided.

According to another characteristic, the light beams are filtered by means of a transparent wall on which opaque graduations are provided.

According to another characteristic, the light beams are filtered by means of a transparent wall in the material of which opaque graduations are provided.

According to another characteristic, at least one measuring level of the coffee corresponds to a transparent or perforated graduation of a void.

According to another characteristic, the device makes it possible to obtain several graduation scales, coffee that is normal, strong or weak.

According to other characteristics relating to filter holders:
The rigid filter holder for holding water for liquid-tight brewing is partially opaque and partially transparent,
The rigid filter holder for brewing is configured with at least one transparent window.
The transparent rigid filter holder that allows light to pass through is provided with a screen-printed opaque mask that is configured on the outside face of the filter holder.
The rigid filter holder is made of two plastic materials, by dual injection, the wall being opaque and graduations being transparent.
Conversely, the rigid filter holder is made of two plastic materials, by dual injection: the wall is transparent and graduations opaque.
According to another characteristic, the flexible filter holder made of nylon mesh comprises at least one gap allowing the passage of light.
According to another characteristic, the flexible filter holder basket is a “skeleton” made of a structure consisting of graduations and numerals and voids.
According to another characteristic, at the base of the rigid or flexible filter holder and along its sides, spaces are configured that are able to house, with play, crimped strips of the filter so that without bending them, the filter that is put into place is properly centered and properly pressed against the walls of the filter holder before being unfolded.
According to another characteristic, the filter holder is provided with transparent horizontal bands, alternating with opaque, black or colored bands.

Another series of characteristics relates to the light source or sources:
All of the light source types, white or color consistent with the electrical standards that are applicable to coffee makers, can be used without restriction: incandescent lights, fluorescent lights, halogen lights, LED (Light Emitting Diodes), in every shape, lights, spotlights, panel lights, strip lights, light-emitting units, mounted by pin, screw, or bayonet clasp.
The light source is natural light.
There are multiple light sources; it is a combination of natural light or artificial light.
The light coming from the light source is projected directly or else reflected by all optical systems without limitation, diffraction, reflection, mirror, refraction, prisms, lenses, magnifying lenses . . . .
The flat or curved geometric-shaped devices for reflecting light are fixed or adjustable.
The light source is reflected and enhanced by deflectors.
The coffee maker is equipped with a closed space, able to accommodate a light source.
The space for the light unit has a part that opens for changing the light source.
One of the walls of the space is able to accommodate a removable mask.
The mask is removable and is perforated by the graduations.
The space of the unit is partially or totally transparent and perforated.
The mask of graduations is made of any material—rigid, flexible, opaque—and it has cutouts that allow the light to pass through.
The mask is fixed or removable, mounted on slides, prongs or any other mechanical mounting device.
The mask is made of transparent material, a film perforated with graduations and glued at the top.
The illuminating mask is painted, or screen-printed, fluorescent, or coated by any other non-limiting technique for printing on the transparent material.
The graduated mask is, on the outside surface, incorporated into the thickness of the rigid filter holder, on the inside surface of the rigid filter holder, incorporated with the removable flexible filter holder, or else it is offset from the filter holder and placed on the light unit, or even mounted at all points of the coffee holder, base, body, filter holder, that can be put into contact with the water reservoir paper filter, lids . . . .
The power supply for the light source is the public power grid, batteries, or photovoltaic energy.

Another series of characteristics relates to the activation of the light source.
The light source is controlled by a switch that is independent of that of the electrical resistor for boiling the water, such that the boiling of the water is not started during the coffee powder measuring operation.
The switch is a rocker or rotary switch having two positions with a red safety indicator.
The switch is of the push-button type with a positive safety action.
A single light source is used to light up the mask and the red light indicators of the switches.
The activation of the source is programmed and/or timed.

Another series of characteristics relates to the LED light sources.
The LEDs are incorporated into a transparent light unit that supports the mask of graduations, and it is placed in a position of contact with the filter.
The LEDs are bulbs, light strings, or light strips; they are white or colored.
When the LEDs of graduations are placed on a filter holder that can be detached from the coffee maker, their electric power is provided by a bearing contact connection, of the type used for cordless electric kettles that are installed on a stand.
Alternatively, the LEDs of graduations are powered by alkaline-type batteries placed in a housing made in the removable filter holder.

FIG. 1 indicates in a cutaway view a filter holder in the shape of a truncated cone that is equipped with the innovation.

FIG. 2 is a view along line a-a of the graduation device as viewed from the inside of the rigid filter holder (without the paper filter).

The body of the rigid filter holder (1) that is shown has a truncated-cone shape, adapted to the sizes of the standard-sized filters (standard cone-shaped Melitta 4, 2 or 6 type). The liquid-tight rigid filter holder is placed on the body of the coffee maker on point or linear cradles (2) of the console type, by means of supports (3); at the bottom of the filter holder is the perforation (4) that is automatically sealed by the spring-loaded anti-drip element (5). The walls of the rigid filter holder (1) are opaque, but a transparent gap (6) is furnished for the passage of light beams coming from the light source (13). To make it easier to grasp when it is removed from the coffee maker, the filter holder (1) is provided with a lug (7).

Inside the rigid filter holder, a flexible removable filter holder (8) is generally present that consists of a support framework and of metal or plastic mesh; a gap (9) is cut on one part that follows, of a size that is at least identical to that of the transparent gap (6). This filter holder is equipped with either a handle or with a gripping tab, for the purpose of easily removing it and throwing away the paper filter (10) containing the coffee powder (11) once brewing is finished.

For the measuring function, besides the gaps (6) and (9) added to the filter holders, a light unit (12) is added or properly configured with the body of the coffee maker. This unit is a space that houses the light source (13) and a mask (14), perforated with graduations (15) and numerals (16). The light source (13) is powered by a cord (17), which is itself connected optionally to a low-voltage transformer (not shown) housed in the base of the coffee maker or in its body and to a switch with the light indicators (not shown) and attached to the coffee maker either on the base or else the body of the coffee maker. The bottom (18) of the light unit can be removed by means of lugs (20) to access the light source to replace it. The bottom (18) is perforated with ventilation holes (19). To modify the measuring and the graduations according to country, the mask (14) is interchangeable; it is hooked to the unit by lugs (21).

The innovation operates as follows. The paper filter is placed, without folding the crimped edges (35), into the spaces (36). Then, the filter is unfolded, and its walls come into contact with the filter holder but not on the bottom line, nor that of the side; it is suspended.

When the light source (13) is switched on by means of its own switch, the light directed toward the outer face of the paper filter (10) is blocked by the opaque mask (14), but it passes through it via the perforations of the graduations (15) and numerals (16); then, the light beams pass through the liquid-tight and transparent window (6), and then through the second open window (9) and are projected onto the back of the paper filter that has been put into place. After water is poured into the reservoir to the number of cups to be prepared, the coffee powder is in turn poured directly from the package of ground coffee into the filter up to the level corresponding to the desired number of cups selected for the water (2, 4, 6, 8, 10).

FIG. 2 indicates/shows a type of graduation to be projected that is made by level lines in the shape of void dashes (15) and numerals (16). The lines for levels can take on any geometric shapes without limitation: rectangles, triangles to show a progression, hoops, stairs. A single filter holder can accommodate several measuring levels.

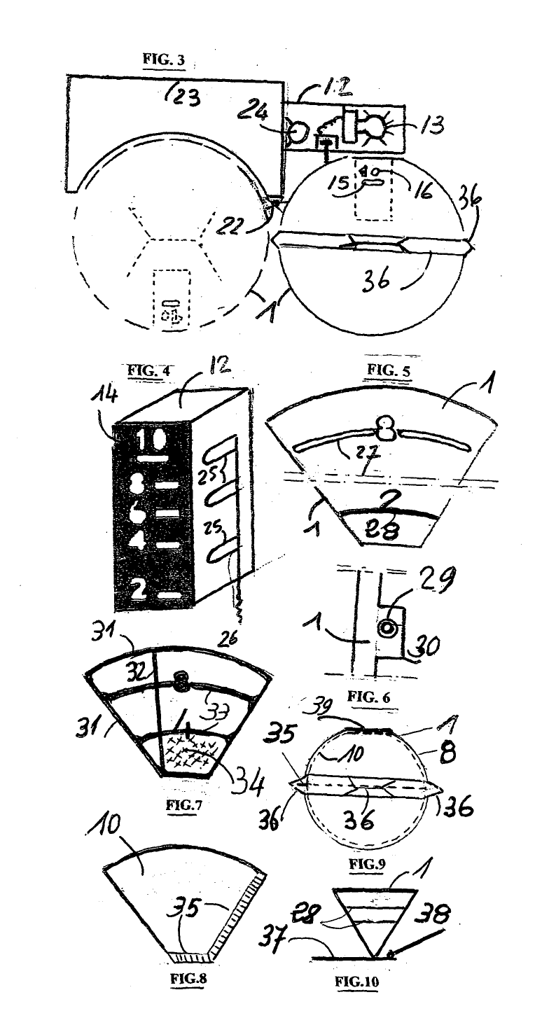

FIG. 3 shows an embodiment of the innovation on a coffee maker having a swiveling filter, characterized in that the light unit is outside of the body of the coffee maker next to the water reservoir.

In this configuration, the filter holder (1) swivels on the pins (22) that are integral with the body of the coffee maker. In the brewing position, the filter holder is against the water reservoir (23); in the measuring position, the filter holder (1) swivels about 180°, thus it is disengaged from the head for the incoming water stream, and it is then pressed against the light unit (12). The latter is made of transparent or translucent material. The translucent material offers the advantage of allowing the light to pass through while concealing the components placed inside. Among these components are the light source (13), optionally a low-voltage transformer (24), and a push-button switch with a red light safety indicator light (25). The grouping of all of these functions, switch, lighting, and voltage transformation into a single unit, makes it possible at any given time to create electrical safety conditions in a closed space and to reduce the cost of production.

The filter holder (1) is opaque, while the marks (15) and the numerals (16) are transparent and are made by dual injection of the filter holder. In the measuring position, the filter holder (1) is in contact with the push-button light switch, the contact is ensured, the bulb (13) lights the translucent or transparent unit (18), and the light illuminates the graduations and the numerals, which become readily readable through the paper or synthetic material filters. When the filter holder is swiveled into the brewing position, the released switch (25) opens, and the illumination of the light unit is extinguished.

In an alternative solution, not shown, the lighting source is placed behind the water reservoir (23) whose walls are transparent or translucent; actually, a light environment even of weak intensity is enough to make the graduations easily readable. The source is also placed on the base and directs a light stream upward, or else it is in the lid of the tank and in this case emits a beam directed downward.

FIG. 4 depicts a light projector unit solution illuminated by LEDs (25) connected by a conductor (26). The face in contact with the filter holder in the measuring position is equipped with the mask (14), which allows the light to pass through the parts (15) and (16). The mask is made by screen-printing or an adhesive flexible film, or a perforated plate, fastened to the unit. In this configuration, the filter holder (1) is entirely transparent, made by single injection; it is put into contact with the light unit (18). The same result is obtained by using a transparent material for the rigid filter holder, covered with an opaque surface treatment, except facing the graduations.

FIG. 5 shows two embodiments of the filter holder. An opaque filter holder (3) is provided with graduations of broken hoops made of transparent material (27). Conversely, a filter holder (1) is provided with opaque graduations (28) also in the form of a continuous hoop all the way around the filter holder.

FIG. 6 shows an LED light source (29) that, built into the material of the filter (1) in a thickened region (30), indicates the measuring level.

FIG. 7 shows an embodiment in which the filter holder (8) is of the skeletal type, characterized in that its edges (31), its stiffeners (32), as well as the level lines of the graduations (33), and the associated numerals constitute the framework and the rigidity. The graduation lines (33) are horizontal hoops. This skeleton is placed in a completely transparent liquid-tight filter holder, gives the maximum height line to the graduations; equipped with a handle, it makes it possible to hold and handle the paper filter. Provided with a filtering mesh (34), it is a permanent filter.

FIG. 8 shows the unfolded paper filter (10) and the crimped borders (35) on the base and on the side so as to properly press the paper against the wall of the filter holder (1), shown in top view, in FIG. 9 where (8) is provided on its base and on the sides with reinforcements (36) in which the crimped strips (width 10 mm for a standard No. 4 filter) are housed with a play of at least 3 mm. The flat or curved surface (37) supports graduations configured by protrusion (39) on the wall of the filter holder, improves the contact between the two materials, and prevents any deformation of the light projection. This contact is reinforced by the weight of the coffee powder, which settles the paper filter.

FIG. 10 depicts in cutaway a transparent filter holder (1), with graduations (28) on its outer face, whose base (37) is a horizontal stationary mirror or else a hinged reflecting deflector (38).

1. Device for measuring powdered coffee into a coffee maker having a filter made of paper or of synthetic fiber with truncated cone shapes or having a flat bottom, wherein the graduations of the measuring level are projected on the coffee filter by means of a light source (13) and a graduated mask (14).

2. Device according to claim 1, wherein the coffee maker is equipped with a light source (13) that diffuses light in the direction of the walls of the filter.

3. Device according to claim 1, wherein the light beams coming from the light source pass through a mask perforated with graduation marks (15) and numerals indicating the number of cups to be measured (16), and the mask is placed on the liquid-tight rigid filter holder (1) or the removable flexible mesh filter holder (8).

4. Device according to claim 1, wherein the fixed liquid-tight rigid filter holder (1) or the movable flexible mesh filter holder (8) comprises at least one transparent part (6) that is capable of allowing the projection of the graduations to pass through against the adjacent paper filter.

5. Device according to claim 1, wherein the removable flexible mesh filter holder (8) is provided with a gap (9) that can allow the projection of the graduations to pass through onto the paper filter.

6. Device according to claim 1, wherein each graduated mark (15) of the mask can measure an amount of coffee powder corresponding to the number of cups of the water reservoir of the coffee maker, calculated respectively based on the strength of the desired liquid coffee.

7. Device according to claim 1, wherein the liquid-tight rigid filter holder (1), fixed or removable is made of plastic material by single injection of entirely or partially transparent material.

8. Device according to claim 1, wherein the rigid filter holder (1), fixed or removable is made of plastic material by at least two injections of transparent and opaque material, the body (1) being opaque and the graduations (27) being transparent, or conversely the body (1) transparent and the graduations (28) opaque.

9. Device according to claim 1, wherein the removable flexible filter is made of a plastic material or of synthetic or metallic mesh, has an opaque zone (33) receiving the graduations that are transparent or perforated with a void allowing the light to pass through.

10. Device according to claim 1, wherein the mask for filtering the light beams on the liquid-tight rigid filter holder (1) is made of perforated solid material (27) or else by any printing process, screen-printing, recessed, or raised on its face that is not in contact with the paper filter.

11. Device according to claim 1 claims 1, wherein the mask for filtering the light beams is configured on at least one of the faces of the rigid filter holder, in the thickness of material of the rigid filter (1), on the light unit (12), on the removable flexible filter holder (8), or on the body of the coffee maker (2).

12. Device according to claims 1, wherein the coffee maker is equipped with a unit (12) with a space able to accommodate a light source (13), and whose inside faces are reflective, or that an LED light source (29) is incorporated into the filter holder (1).

13. Device according to claim 1, wherein natural or artificial light is projected directly or else reflected by any optical systems, fixed or adjustable, without limitation, diffraction by prism, diffusion, mirror (37) reflection, refraction, prisms, lenses, or a deflector (38).

14. Device according to claim 1, wherein the activation of the light source is controlled independently from that of the resistor.

15. Device according to claim 1 wherein a single switch with dual contact activates the light source (13) for projecting the graduations and activates the heating resistor of the coffee maker.

16. Device according to claim 1, wherein a single light source is used both for the illumination of the mask for projecting the graduations and for a light indicator signal or signals of the switches for electric power.

17. Device according to claim 1, wherein the light source for projecting the graduations consists of LEDs (26) that are incorporated into a transparent or translucent unit (12), which is equipped with an opaque mask (14) that is perforated with the graduations to be projected.

18. Device according to claim 17, wherein the transparent or translucent unit (12) with incorporated LEDs (26) and comprising a mask for projecting the graduations (14) is placed either on the body of the coffee maker or the liquid-tight rigid brewing filter holder (1).

19. Device according to claim 1, wherein the filter holder with incorporated light unit is powered electrically by an electric contact connection by simple placement, like a cordless electric kettle.

20. Device according to claim 1, wherein the electric circuit for powering the light source is cut off by the switch for turning on the heating resistor when it is powered up, or else by a programmable timer.

21. Device according to claim 1, wherein the light sources are powered by alkaline-type batteries placed in a housing provided in the removable filter holder or any other part of the coffee maker.

22. Device according to claim 1, wherein the contact between paper filter (10) and the filter holder (1) is improved by the slots (36) for the crimped strips (35) and for the protrusion (39), which positions the filter in suspension.

23. Device according to claim 1, wherein the mask is a skeleton consisting of frameworks (31) and (32) for the graduations (33) that, equipped with a filtering mesh (34), have a dual function of mask and permanent filter.

24. Device according to claim 1, wherein the graduation marks (15), (27), (28) and (33) can take on any geometric shapes, with colors, dashes, hoops, triangles, or bands, all in several scales of graduations depending on the strength of the coffee and the country.
